(19) United States
(12) Patent Application Publication
(10) Pub. No.: US 2009/0032318 A1
(43) Pub. Date: Feb. 5, 2009

(54) FUEL CELL VEHICLE

(76) Inventor: Tsukuo Ishitoya, Aichi (JP)

Correspondence Address: KENYON & KENYON LLP, 1500 K STREET N.W., SUITE 700, WASHINGTON, DC, 20005, US

(21) Appl. No.: 12/085,963

(22) PCT Filed: Nov. 22, 2006
(86) PCT No.: PCT/JP2006/323867

§ 371 Date: Jun. 3, 2008

(30) Foreign Application Priority Data
Dec. 12, 2005 (JP) 2005-357958

(51) Int. Cl. B60L 11/18; B60K 1/04; B60R 16/08

(52) U.S. Cl. 180/65.3

(57) ABSTRACT

A high-pressure tank is disposed on a rear side of a vehicle, a fuel cell for consuming a fuel gas in the high-pressure tank is disposed on a front side of the vehicle, and a supply pipe for supplying the fuel gas to a fuel cell from the high-pressure tank is provided. The supply pipe is housed in a tunnel part formed in a shape projecting toward the vehicle interior side at the bottom face of the vehicle in a front-rear direction.

### TECHNICAL FIELD

The present invention relates to a fuel cell vehicle having a pipe to supply a fuel gas to a fuel cell as a fuel-gas consuming device.

### BACKGROUND ART

In general, in a vehicle having a consuming device, such as a fuel cell or a gas engine, disposed on the front side of the vehicle, a fuel gas is supplied from a high-pressure tank disposed on the rear side of the vehicle to the consuming device via a supply pipe. As a technique for a vehicle that has the supply pipe for supplying a fuel gas to the consuming device, providing the supply pipe along the bottom side of the vehicle body floor panel of the vehicle is known (see, for example, Japanese Patent Application Laid-Open JP2000-343959A).

### DISCLOSURE OF INVENTION

With the supply pipe merely provided along the bottom side of the vehicle body floor panel, however, not only the supply pipe is exposed at the lower side of the vehicle but also the supply pipe to which the fuel gas is discharged from the high-pressure tank is cooled down by adiabatic expansion of the fuel gas at the time of discharging the fuel gas, which is likely to affect the performance of a sealant or the like provided at the joint portion or the like of the supply pipe.

The present invention has been made in view of the foregoing situation, and an object of the present invention is to provide a fuel cell vehicle capable of suppressing the influence of temperature dropping at the time of adiabatic expansion of a fuel gas discharged from a high-pressure tank.

To achieve the object, a fuel cell vehicle according to the present invention comprises: a fuel tank disposed on a rear side for storing fuel with a pressure higher than a pressure at a time of consumption; a fuel consuming device disposed on a front side for consuming a fuel gas discharged from the fuel tank; and a supply pipe for supplying the fuel gas discharged from the fuel tank to the fuel consuming device, wherein the supply pipe is housed in a tunnel part formed in a shape projecting toward a vehicle interior side at a vehicle body floor in a front-rear direction.

With the configuration, since the supply pipe is housed in the tunnel part formed to enhance the rigidity of the vehicle body of the fuel cell vehicle particularly against its twisting, heat generated when the fuel gas is consumed in the consuming device on the front side (one side in a direction of travel) of the vehicle is transmitted to the rear side (the other side in the direction of travel) of the vehicle along the tunnel part, thereby the supply pipe surrounded by each of the wall surfaces of the vehicle body floor which define the tunnel part is warmed, so that temperature dropping of the supply pipe, which is caused by adiabatic expansion of the fuel gas, can be suppressed. This can suppress the influence of temperature dropping on a sealant of the supply pipe or the like.

In the fuel cell vehicle, the fuel consuming device may be a fuel cell that generates power by electrochemical reaction of the fuel gas and an oxide gas.

With the configuration, since the heat generated by the fuel cell at the time of power generation is transmitted along the tunnel part, the supply pipe can be moderately heated as compared with the case where the consuming device is a source of generating a high heat equal to or higher than a predetermined temperature, like an internal combustion engine, so that it is possible to well suppress temperature dropping caused by adiabatic expansion of the fuel gas. That is, it is advantageous in the capability of heating the supply pipe more moderately, because the temperature of the exhaust pipe of the fuel cell is generally lower than that of the exhaust pipe of an internal combustion engine.

In the fuel cell vehicle, an exhaust pipe that leads an off gas exhausted from the fuel consuming device outward is preferably housed in the tunnel side by side to the supply pipe.

With this configuration, temperature dropping of the supply pipe can be well suppressed by the exhaust heat of the off gas flowing in the exhaust pipe that is disposed side by side to the supply pipe.

A fuel cell vehicle according to the present invention comprises: a fuel tank disposed on one side in a front-rear direction (one side in a direction of travel) for storing fuel with a pressure higher than a pressure at a time of consumption; a fuel consuming device disposed on an other side in the front-rear direction (the other side in the direction of travel) for consuming a fuel gas discharged from the fuel tank; and a supply pipe for supplying the fuel gas discharged from the fuel tank to the fuel consuming device, wherein the supply pipe is housed in a tunnel part formed in a shape projecting toward a vehicle interior side at a vehicle body floor in a front-rear direction (direction of travel).

As described above, according to the present invention, the influence of temperature dropping at the time of adiabatic expansion of the fuel gas discharged from the high-pressure tank can be suppressed.

### BRIEF DESCRIPTION OF DRAWINGS

FIG. 1 is a schematic plan view of a vehicle according to the present embodiment.

FIG. 2 is a schematic bottom view of the vehicle according to the embodiment.

FIG. 3 is a cross-sectional view along A-A in FIG. 1.

FIG. 4 is a cross-sectional view along B-B in FIG. 1.

### BEST MODE FOR CARRYING OUT THE INVENTION

An embodiment of a vehicle according to the present invention will be described below with reference to the accompanying drawings. The description of the embodiment will be given of a fuel cell vehicle having a fuel cell that generates power upon reception of a reaction gas supplied by way of example. The forward direction of the fuel cell vehicle is called “front” and the rearward direction is called “rear”.

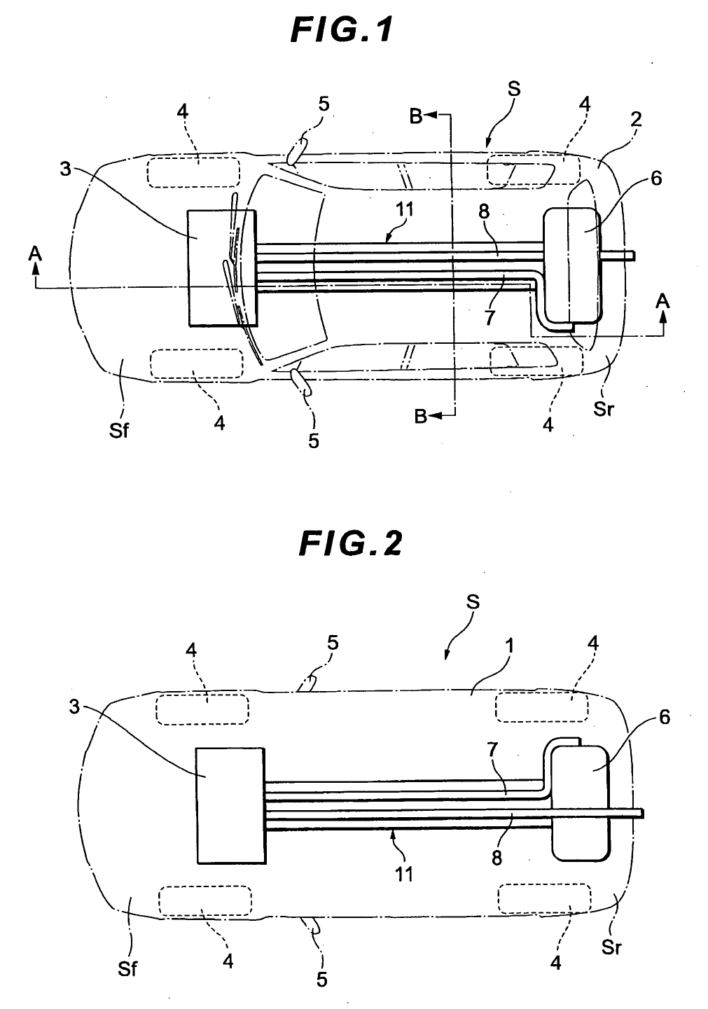

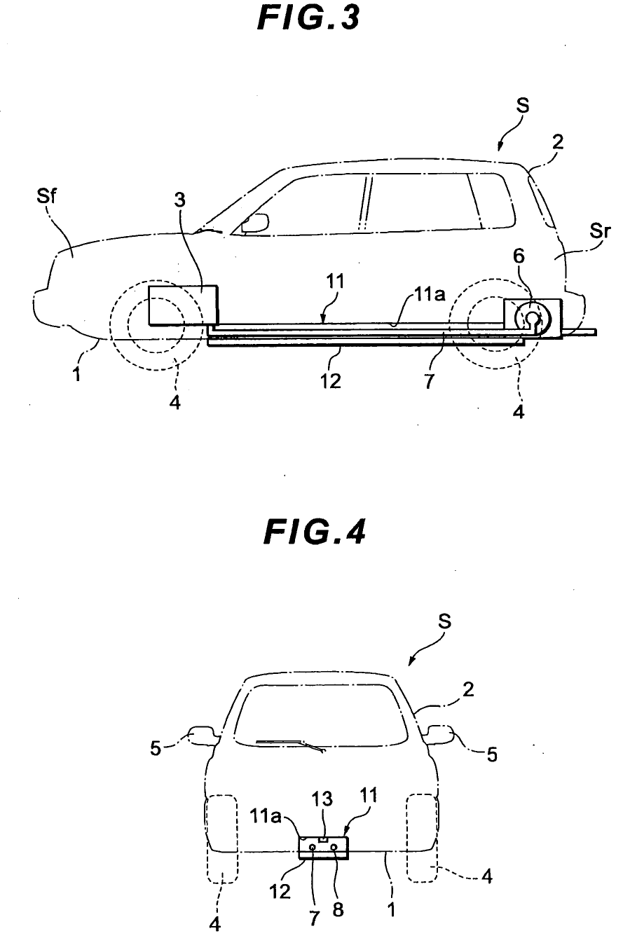

FIG. 1 is a schematic plan view of the vehicle, FIG. 2 is a schematic bottom view of the vehicle, FIG. 3 is a cross-sectional view along A-A in FIG. 1, and FIG. 4 is a cross-sectional view along B-B in FIG. 1.

As illustrated, a vehicle S has a vehicle body floor (floor panel) 1 and a vehicle body 2 provided above the vehicle body floor 1, and has a fuel cell 3 provided on a front side Sf of the vehicle S which is the front side in its direction of travel. In the diagrams, reference numeral 4 denotes a wheel, and reference numeral 5 denotes a door mirror 5.

The fuel cell 3 has a fuel cell stack having a power generating part constituted by stacking a required number of cells which generate power upon reception of a fuel gas and an oxide gas, as reaction gases, supplied. The cell constituting the fuel cell stack comprises an MEA (Membrane Electrode Assembly) having an electrolyte and a pair electrodes disposed on the respective sides of the electrolyte and a pair of separators holding the MEA. In the fuel cell stack constituting the fuel cell 3, a hydrogen gas as a fuel gas and air as an oxide gas are let to flow to both sides of the MEA, and so the fuel cell 3 generates power due to electrochemical reaction of the hydrogen gas and oxygen in the air via the MEA.

Disposed on a rear side Sr of the vehicle S is a high-pressure tank (fuel tank) 6 filled with a hydrogen gas as a fuel gas at a pressure (e.g., 35 MPa, 70 MPa or the like) exceeding a pressure at the time of consumption (e.g., 200 kPa). The fuel cell 3 and the high-pressure tank 6 are connected by a supply pipe 7 for supplying the fuel gas, so that the supply pipe 7 supplies the hydrogen gas in the high-pressure tank 6 to the fuel cell 3.

An exhaust pipe 8 for exhausting a fuel cell off gas (oxide off gas, hydrogen off gas) generated after power generation is connected to the fuel cell 3, and is placed side by side to the supply pipe 7 and led toward the rear side Sr of the vehicle S.

A tunnel part 11 is formed in the vehicle body floor 1 constituting the vehicle S at approximately center in the width direction of the vehicle S. The tunnel part 11 comprises a rib formed in the vehicle body floor 1 so as to extend in, for example, the front-rear direction of the vehicle S, and is formed in a shape projecting upward (the vehicle interior side). That is, the tunnel part 11 is formed in order to enhance the rigidity, particularly, the rigidity of the vehicle body against twisting by increasing the second moment of area of the vehicle body floor 1.

The supply pipe 7 and the exhaust pipe 8 are housed in the tunnel part 11 formed to enhance the rigidity of the vehicle body floor 1 of the vehicle S. An under cover 12 of a resin, for example, is attached to the tunnel part 11 at an opening portion of the lower side thereof, so that the tunnel part 11 is closed by the under cover 12.

A gas detection sensor 13 which detects a hydrogen gas or a fuel gas is attached to a ceiling part 11a constituting the tunnel part 11 at a location rearward of the vehicle S. Further, though not illustrated, a hydrogen pump that circulates the hydrogen off gas, an air compressor that supplies air as the oxide gas to the fuel cell 3, and a humidifier that humidifies the air to be supplied are housed inside the tunnel part 11.

In the vehicle S according to the above embodiment, because the supply pipe 7 from the high-pressure tank 6 is housed in the tunnel part 11 formed in the vehicle body floor 1 of the vehicle S, the heat generated at the time of power generation caused by consumption of the fuel gas in the fuel cell 3 as the consuming device disposed on the front side Sf of the vehicle S is transmitted to the rear side Sr of the vehicle S along the tunnel part 11, thereby the supply pipe 7 surrounded by each of the wall surfaces of the vehicle body floor which define the tunnel part 11 is warmed.

This makes it possible to suppress temperature dropping of the supply pipe 7 caused by adiabatic expansion of the fuel gas, so that the influence of temperature dropping on the sealant of the supply pipe 7 or the like can be suppressed.

Because the consuming device is the fuel cell 3 in the present embodiment, the temperature of the fuel cell off gas exhausted from the fuel cell 3 through the exhaust pipe 8 is not higher as compared with the case where the consuming device is an internal combustion engine (e.g., gas engine). Accordingly, even the side-by-side provision of the supply pipe 7 and the exhaust pipe 8 in the tunnel part 11 can moderately heat the supply pipe 7 with the exhaust heat of the fuel cell off gas flowing in the exhaust pipe 8, thus the influence of temperature dropping on the supply pipe 7 caused by adiabatic expansion of the fuel gas can be suppressed.

It is possible to suppress the influence of the temperature dropping only on the supply pipe 7 but also on the hydrogen pump, the air compressor and the humidifier or the like housed in the tunnel part 11.

Further, because the tunnel part 11 is necessarily formed to enhance the rigidity of the vehicle body floor 1 of the vehicle S, housing the supply pipe 7 in the tunnel part 11 can achieve the effective use of the space in the vehicle S, and also can avoid exposure of the supply pipe 7.

With the vehicle S, even if great force is applied from sideward of the vehicle S, housing the supply pipe 7 in the tunnel part 11 formed to enhance the rigidity of the vehicle body can also suppress the influence of the sideward external force on the supply pipe 7.

Because the gas detection sensor 13 which detects a hydrogen gas or a fuel gas is attached to the ceiling part 11a of the tunnel part 11 located rearward of the vehicle S, it is possible to surely detects a fuel gas containing the hydrogen gas remaining along the ceiling part 11a, even if the fuel gas leaks from the supply pipe 7.

Although the foregoing description of the embodiment has been given of the vehicle S having the fuel cell 3 provided as the consuming device by way of example, the present invention is of course applicable to vehicles equipped with a consuming device, such as a gas engine. Since the exhaust pipe 8 of the fuel cell 3 is generally lower in temperature than the exhaust pipe of the internal combustion engine or the like, however, the side-by-side provision of the exhaust pipe and the supply pipe 7 in the tunnel part 11 is advantageous in that the vehicle S having the fuel cell 3 mounted therein can heat the supply pipe moderately.

The high-pressure tank of the present invention is not limited to a gas tank, such as a high-pressure hydrogen gas tank etc., and may be a liquid fuel tank, such as a liquid hydrogen tank etc. Further, the high-pressure tank of the present invention may be a tank having a hydrogen storing alloy.

### INDUSTRIAL APPLICABILITY

According to the present invention, the influence of temperature dropping at the time of adiabatic expansion of a fuel gas discharged from a high-pressure tank can be suppressed. Therefore, the present invention can widely applied to vehicles that have such demand.

1. A fuel cell vehicle comprising:
a fuel tank disposed on a rear side for storing fuel with a pressure higher than a pressure at a time of consumption;
a fuel consuming device disposed on a front side for consuming a fuel gas discharged from the fuel tank; and
a supply pipe for supplying the fuel gas discharged from the fuel tank to the fuel consuming device,
wherein the supply pipe and an exhaust pipe for leading an off gas exhausted from the fuel consuming device outward are disposed side by side, and are housed in a tunnel part formed in a shape projecting toward a vehicle interior side at a vehicle body floor in a front-rear direction.

2. The fuel cell vehicle according to claim 1, wherein the fuel consuming device is a fuel cell that generates power due to electrochemical reaction of the fuel gas and an oxidant gas.

3. (canceled)

4. A fuel cell vehicle comprising:
a fuel tank disposed on one side in a front-rear direction for storing fuel with a pressure higher than a pressure at a time of consumption;
a fuel consuming device disposed on an other side in the front-rear direction for consuming a fuel gas discharged from the fuel tank; and
a supply pipe for supplying the fuel gas discharged from the fuel tank to the fuel consuming device,
wherein the supply pipe and the exhaust pipe for leading an off gas exhausted from the fuel consuming device outward are disposed side by side, and are housed in a tunnel part formed in a shape projecting toward a vehicle interior side at a vehicle body floor in a front-rear direction.
